(19) United States
(12) Patent Application Publication
(10) Pub. No.: US 2023/0169462 A1
(43) Pub. Date: Jun. 1, 2023

(54) AUTOMATED INVENTORY MANAGEMENT SYSTEM AND METHOD THEREOF

(71) Applicant: INDUSTRIAL TECHNOLOGY RESEARCH INSTITUTE, Hsinchu (TW)

(72) Inventors: Sian-Hong HUANG, Kaohsiung City (TW); En-Tzu WANG, Kaohsiung City (TW); Chi-Yuan YEH, Hsinchu City (TW); Cheng-Yo HUANG FU, Tainan City (TW)

(73) Assignee: INDUSTRIAL TECHNOLOGY RESEARCH INSTITUTE, Hsinchu (TW)

(21) Appl. No.: 17/696,644

(22) Filed: Mar. 16, 2022

(30) Foreign Application Priority Data
Nov. 30, 2021 (TW) 110144716

(51) Int. Cl. G06Q 10/08; G06Q 10/06; G06Q 30/06; G06N 5/02

(52) U.S. Cl. CPC G06Q 10/0875; G06Q 10/06315; G06Q 30/0633; G06N 5/022

(57) ABSTRACT

An automated inventory management method is provided. Historical sales states of multiple stores are received, and models of each store and each category of products are pre-trained by a pre-training module. States of each store and each category of products are obtained by a multi-store-multi-category training module, and horizontal and vertical relevance training based on the pre-trained models of each store and each category of products is conducted. Relevance between stores, horizontal relevance between categories of products, and vertical relevance between multiple stores and multiple categories of products are determined by a state analysis module, so that multiple stores and categories of products with high correlation are linked to modify expected sales of each store and each category of products. Orders for multiple categories of products in each store are placed and purchase volumes of multiple categories of products in each store are determined by an inventory decision module.

This application claims the benefit of Taiwan application Serial No. 110144716, filed Nov. 30, 2021, the disclosure of which is incorporated by reference herein in its entirety.

### TECHNICAL FIELD

The disclosure relates in general to an automated inventory management, and more particularly to an automated inventory management system and a method thereof.

### BACKGROUND

In the modern society, the competition in each industry is getting more and more intensified. Therefore, it has become a great concern for people in each industry to effectively reduce inventory cost. Regarding inventory decisions, purchase order is based on demand driven material requirements planning (DDMRP), and is adjusted according to the average and standard deviation of historical sales, delivery time, and demand variation parameters. The demand varying parameter is manually set and greatly relies on human experience. As uncertainty increases, inventory cost may increase, and inventory shortage caused by under-purchase may occur.

Besides, the terminal device of each store can be connected to the server of the headquarter through the Internet, so that the headquarter can obtain the inventory information and sales information of each store to perform sales planning, such as discount, buy one get one free, or promotion of particular product. Due to regional factors, the products sold in the stores of various regions have a large variety and people in various regions may have different favorites. Since the inventory management system cannot provide effective purchase suggestions of multiple products to the staff in each store, the situation of over-inventory and out of stock may easily occur.

Therefore, it has become a prominent task for the industries to perform automated planning of multi-store-multi-category inventory to provide more efficient purchase suggestions.

### SUMMARY

The present disclosure relates an automated inventory management system and method used to create a complete set of multi-store-multi-category pre-training modules for assisting the staff in each store with the purchase of products.

According to one embodiment, an automated inventory management system is provided. The automated inventory management system includes a pre-training module of a processor, a multi-store-multi-category training module of the processor, a state analysis module and an inventory decision module of the processor. The pre-training module is used to receive historical sales states of multiple stores including historical sales state of all categories of products, historical sales state of all stores and total sales state of each store and each product. The pre-training module is used to pre-train the models of each store and each category of products according to the historical sales states of each store and each category of products. The multi-store-multi-category training module is used to obtain state of each store and state of each category of products according to the total sales state and conduct horizontal and vertical relevance training based on the pre-trained models of each store and each category of products. The state analysis module is used to determine horizontal relevance between multiple stores, horizontal relevance between multiple categories of products and vertical relevance between multiple stores and multiple categories of products, so as to link multiple stores and multiple categories of products with high correlation to modify expected sales of each store and each category of products. The inventory decision module is used to place orders of multiple categories of products in each store and determine purchase volume of multiple categories of products in each store.

According to another embodiment, an automated inventory management method is provided. The automated inventory management method includes the following steps. Historical sales states of multiple stores comprising historical sales state of all categories of products, historical sales state of all stores and total sales state is received by a pre-training module of a processor, and models of each store and each category of products are pre-trained by the pre-training module according to the historical sales states of each store and each category of products. State of each store and state of each category of products are obtained by a multi-store-multi-category training module of the processor according to the total sales state and horizontal and vertical relevance training is conducted based on the pre-trained models of each store and each category of products. The horizontal relevance between multiple stores, the horizontal relevance between multiple categories of products and the vertical relevance between multiple stores and multiple categories of products is determined by a state analysis module of the processor, so as to link multiple stores and multiple categories of products with high correlation to modify expected sales of each store and each category of products orders of multiple categories of products in each store is placed by an inventory decision module of the processor and purchase volume of multiple categories of products in each store is determined.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an automated inventory management system according to an embodiment of the present disclosure.

FIG. 2 is a schematic diagram of an automated inventory management system performing pre-training on multiple stores or multiple categories of products according to an embodiment of the present disclosure.

FIG. 3 is a schematic diagram of an automated inventory management system performing relevance training on multiple stores and multiple categories of products according to an embodiment of the present disclosure.

FIG. 4 is a schematic diagram of an automated inventory management method according to an embodiment of the present disclosure.

FIG. 5 is a schematic diagram of an automated inventory management interface according to an embodiment of the present disclosure.

FIG. 6 is a schematic diagram of purchase analysis for different categories of products.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of exemplary embodiments are described below with accompanying drawings. These exemplary embodiments can be implemented in many different ways, and are not limited to the examples elaborated here. To the contrary, these embodiments make the present disclosure completer and more comprehensive, such that the concepts of the present disclosure can be fully understood by anyone ordinarily skilled in the technology field of the present disclosure. The structures, characteristics or features disclosed in the present disclosure can be combined in one or more embodiments in any suitable way.

Besides, accompanying drawings are schematic illustrations of the present disclosure and are not based on actual proportion of the products. Designations common to the accompanying drawings and embodiments are used to indicate identical or similar elements, and descriptions of the identical or similar elements are not repeated. Some block diagrams illustrated in the accompanying drawings represent functional entities, and do not have to correspond to the entities which are physically or logically independent. These functional entities can be realized by way of software, in one or more hardware modules or as integrated circuits, or can be realized in different networks and/or processors and/or micro-controllers. For example, the pre-training module, the multi-store-multi-category training module, the state analysis module, and the inventory decision module as disclosed in the present disclosure can be realized by way of software, in one or more hardware modules or integrated circuits.

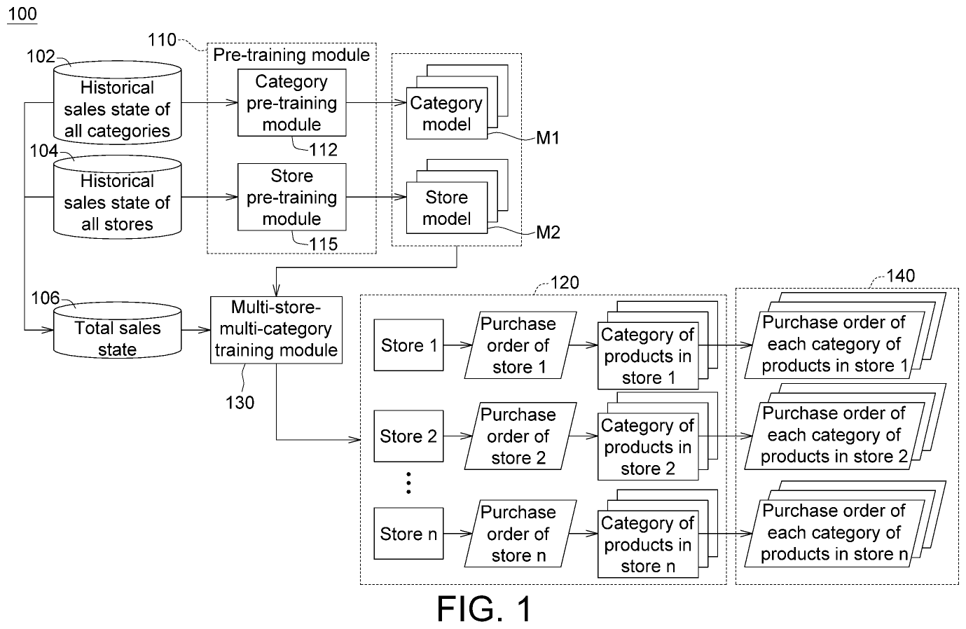

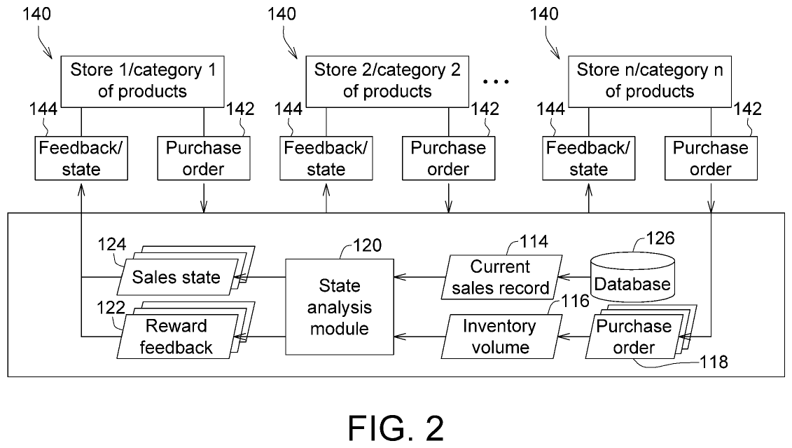

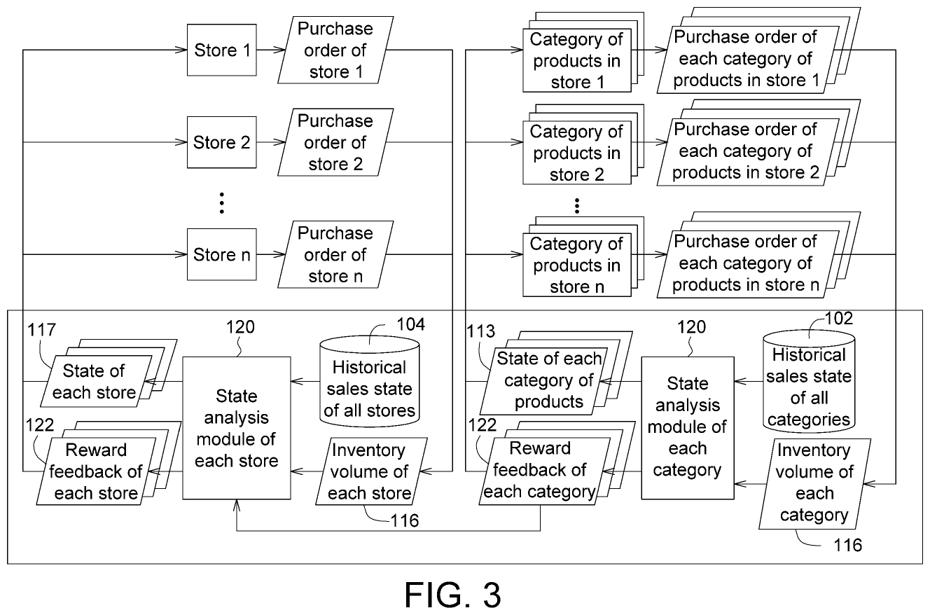

Refer to FIGS. 1, 2 and 3. FIG. 1 is a schematic diagram of an automated inventory management system 100 according to an embodiment of the present disclosure. FIG. 2 is a schematic diagram of the automated inventory management system 100 performing pre-training on multiple stores or multiple categories of products according to an embodiment of the present disclosure. FIG. 3 is a schematic diagram of the automated inventory management system 100 performing relevance training on multiple stores and multiple categories of products according to an embodiment of the present disclosure. The automated inventory management system 100 includes a pre-training module 110, a state analysis module 120, a multi-store-multi-category training module 130 and an inventory decision module 140. The pre-training module 110 can forecast the sales of multiple categories of products in each store according to a historical sales state 102 of all categories of products, a historical sales state 104 of all stores, and a total sales state 106 of each store and each category of product (including the average of sales and standard deviation of each category of products as well as the sales state and standard deviation of sales of each store).

In an embodiment, the historical sales states 102 and 104 are such as historical sales of a category of products over 52 weeks prior to the time point t, average sales is such as the average of historical sales of a category of products over 13 weeks prior to the time point t; standard deviation is such as the standard deviation of historical sales of a category of products over 13 weeks prior to the time point t. Sales forecast of multiple categories of products in each store is a rough estimate of expected sales of multiple categories of products in each store for the next period, that is, period t+1. For example, if sales forecast of a category of products in each store is greater than the average of historical sales over 13 weeks, the inventory level is increased. Meanwhile, the supplier may estimate a higher demand, and each store will increase the forecast to avoid inventory shortage. If the sales forecast of a category of products in each store is less than the average of historical sales over 13 weeks, the inventory level is decreased. Meanwhile, the supplier may estimate a lower demand, and each store will decrease the forecast to avoid over-inventory.

The pre-training module 110 includes a category pre-training module 112 and a store pre-training module 115. The category pre-training module 112 can pre-train each category of products model M1 according to the historical sales state 102 of each category of products. The store pre-training module 115 can pre-train each store model M2 according to the historical sales state 104 of each store.

However, the pre-training performed on the models of one store and one category of products according to the historical sales state 102 of each category of products and the historical sales state 104 of each store by the pre-training module 110 does not consider relevance between multiple stores or multiple categories of products (including regional relevance between stores and relevance between categories of products). Therefore, when forecast variation is greater than the safety level (such as the standard deviation of sales), it is still possible that each store may over-purchase or under-purchase and the risk and cost of over-inventory or under-inventory may increase. The above phenomenon is referred as “forecast inflation”. To avoid forecast inflation, in the present embodiment illustrated in FIG. 1, the multi-store-multi-category training module 130 of the automated inventory management system 100 can obtain state 117 of each store and state 113 of each category of products according to the total sales state 106 and conduct horizontal and vertical relevance training based on the pre-trained model M1 of each category of products and the pre-trained model M2 of each store. The state 117 of each store includes inventory information (out-of-stock rate and current inventory volume), sales forecast of each store, and technical indicators of historical sales of each store (such as average sales record and standard deviation). The state 113 of each category of products includes inventory information (out-of-stock rate and current inventory volume), and technical indicators (such as average sales record and standard deviation) of the sales forecast of each category of products, the historical sales of each category of products. Horizontal and vertical relevance training includes a horizontal correlation factor and a vertical correlation factor. The horizontal correlation factor of the horizontal relevance training between stores can be the correlation coefficient of historical sales, regional correlation or the correlation of some grouping methods for grouping stores. The horizontal correlation factor between products can be the association rule or the correlation of the method for grouping products. The vertical correlation factor integrates the relevance between stores and products, and controls the strength of vertical correlation.

As indicated in FIGS. 1 and 2, after relevance training of multiple stores and multiple categories of products is completed, the state analysis module 120 can further forecast the sales of each store and each category of products for the next period according to the horizontal relevance between multiple stores (including regional and sales relevance between stores), the horizontal relevance between multiple categories of products (including relevance between different categories of products in each store) and the vertical relevance between stores and products (including relevance between multiple stores and multiple categories of products) to avoid the staff determining expected sales of each store according to their past experience and subjective judgement.

Refer to FIG. 1. After the state analysis module 120 forecasts the sales of multiple stores and/or multiple categories of products for the next period, the automated inventory management system 100 further places orders of multiple categories of products in each store through the inventory decision module 140 and determines purchase volume of multiple categories of products in each store.

Refer to FIG. 2. Let n stores or n categories of products be taken for example. The purchase order of each store or each category of products can be pre-trained according to the following methods. As indicated in FIG. 2, the state analysis module 120 calculates a reward feedback 122 according to the current sales record 114 and current inventory volume 116 of each store and each category of products and the purchase order 118 for the previous period, and directly inputs the reward feedback 122 of each store and each category of products and the sales state 124 of each store and each category of products to the inventory decision module 140 to place orders of each store and each category of products. After the predetermined time interval, whenever necessary, the state analysis module 120 can evaluate and train the inventory decision module 140 again.

In an embodiment, (1) when the sum of the inventory (stockₜ) of a category of products and the purchase order (orderₜ₋₁) for the previous period is greater than or equivalent to the sum of the expected sales (saleₜ₊₁) of the category of products in the next period and the standard deviation (stdₜ) of sales in the current period, that is, stockₜ+orderₜ₋₁≥saleₜ₊₁+stdₜ, the inventory decision module 140 estimates that the category of products has an excess of inventory, and needs to downwardly adjust the purchase order 142 of the category of products in the next period to reduce forecast error; (2) when the sum of the inventory (stockₜ) of the category of products and the purchase order (orderₜ₋₁) for the previous period is greater than or equivalent to the expected sales (saleₜ₊₁) of the category of products in the next period and less than the sum of the expected sales (saleₜ₊₁) of the category of products in the next period and the standard deviation (stdₜ) of sales in the current period, that is, saleₜ₊₁+stdₜ≥stockₜ+orderₜ₋₁≥saleₜ₊₁, the inventory decision module 140 estimates that the inventory of the category of products meets expected sales and there is no need to adjust the purchase order 142 of the category of products in the next period; (3) when the expected sales (saleₜ₊₁) of the category of products in the next period is greater than the sum of the inventory (stockₜ) of the category of products and the purchase order (orderₜ₋₁) for the previous period, that is, saleₜ₊₁>stockₜ+orderₜ₋₁, the inventory decision module 140 estimates that the inventory of the category of products does not meet expected sales, and needs to upwardly adjust the purchase order 142 of the category of products in the next period to reduce forecast error.

After the inventory decision module 140 adjusts the purchase order 142, the purchase order can be stored in a database 126 and used in the next data analysis, the purchase order 142 meeting the expected sales of each store and/or each category of products in the next period can be used as a feedback data 144 for calculating a purchase order of each store and/or each category of products in the period after the next period for the state analysis module 120 to calculate the reward feedback 122. The reward feedback 122 can be the mean absolute percentage error (MAPEₜ) of sales (saleₜ) of each store and/or each category of products in the current period, that is, the percentage of the absolute difference between the sales (saleₜ) in the current period and the sales forecast (stockₜ+orderₜ₋₁) to the sales (saleₜ) in the current period, and the larger the reward feedback 122, the larger the forecast error; and vice versa.

As indicated in FIG. 3, the state analysis module 120 can further determine the horizontal relevance between multiple stores (including regional and sales relevance between stores) and the horizontal relevance between multiple categories of products (including relevance between different categories of products in each store), so as to link up the reward feedback 122 of top N stores or categories of products with high correlation to obtain a first group of correlation factors. High correlation can be defined as the confidence of the correlation analysis of multiple stores or the confidence of the correlation analysis of multiple categories of products being greater than 0.8, or, the correlation coefficient of the correlation analysis of multiple stores or multiple categories of products being greater than 0.8. Thus, if the quantity of top N stores or categories of products with high correlation is not set, a user-defined threshold value can be used as a comparison basis. For example, when the correlation coefficient is higher the threshold value, this indicates that the sales of stores 1 and 2 are close or similar to each other; when the sales of category 1 of products in store 1 increases or decreases, then the sales of category 1 of products in store 2 increases or decreases synchronically, this indicates that the two stores have high correlation. Or, when the sales of category 1 of products increases or decreases, the sales of category 2 of products increases or decreases synchronically, this indicates that the two categories of products have high correlation.

The calculation of correlation is as follows. The reward feedback Reward_{A} of a store A or a category of products A is multiplied by a weight coefficient α, then the average value of the reward feedback Reward_{X} of top N stores or categories of products with high correlation multiplied by the set of correlation factors r_{X,A} is multiplied by a weight coefficient (1−α), then the products are summed to obtain a modified reward feedback Reward′_{A} of the store A or the category of products A. The modified reward feedback can be expressed as:

$${Reward}_{A}^{′} = α \times {Reward}_{A} + ( 1 - α ) \times \frac{1}{N} {\sum }_{X \neq A} {r}_{X , A} \times {Reward}_{X} , 0.5 \leq α < 1.$$

The correlation factor r_{X,A} relates to regional factor, seasonal factor, promotion or consumer preference for judgment.

Refer to FIG. 3. The state analysis module 120 can further determine the vertical relevance between multiple stores and multiple categories of products, so as to link up the reward feedback of top N stores and categories of products with high correlation to obtain a second group of correlation factors. For example, when the correlation coefficient is higher than the threshold value and the sales of category 1 of products in stores 1 and 2 increases or decreases, the sales of categories 2 and 3 of products in stores 1 and 2 increases or decreases synchronically, this indicates that categories 1, 2 and 3 of products in stores 1 and 2 have high correlation. Thus, apart from the horizontal relevance between stores, the vertical relevance between multiple stores and multiple categories of products also need to be considered.

The calculation of correlation is as follows. The store reward feedback StoreReward_{A} of a store A is multiplied by a weight coefficient β, and the average value of the set of reward feedbacks CatogoryReward_{A} of other top N categories of products having high correlation with a category of products in store A is multiplied by a weight coefficient (1−β), then the two products are summed up to obtain a modified store reward feedback StoreReward′_{A} of the store A. The modified store reward feedback can be expressed as:

$${StoreReward}_{A}^{′} = β \times {StoreReward}_{A} + ( 1 - β ) \frac{1}{2} {{\sum }_{i = 1}}^{N} {CategoryReward}_{A , i} , 0.5 \leq β < 1.$$

It can be known from the automated inventory management system 100 of the above embodiment that the inventory decision module 140 can place order according to the modified reward feedback Reward′_{A} and the modified store reward feedback StoreReward′_{A}, so that the determination of expected sales of each store does not need to rely on the staff's past experience and subjective judgement, and forecast error as well as the probability and cost of over-inventory or out-of-stock can be reduced.

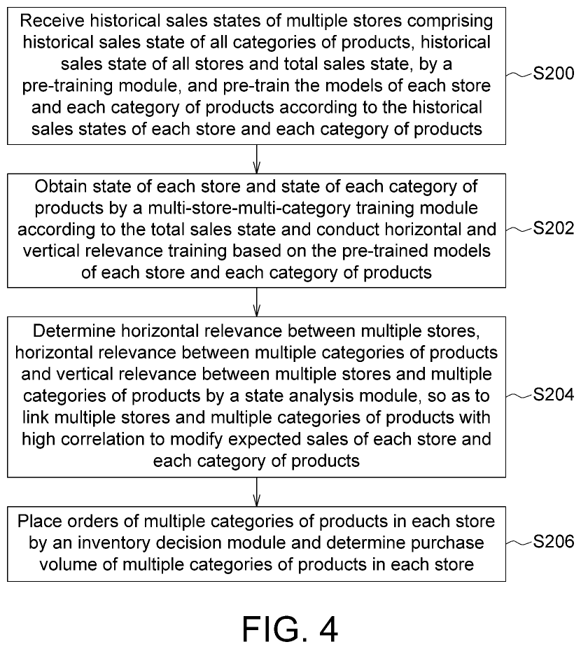

Refer to FIG. 1 and FIG. 4. FIG. 4 is a schematic diagram of an automated inventory management method according to an embodiment of the present disclosure. According to the above embodiment, the automated inventory management method includes the following steps S200-S206. In step S200, historical sales states of multiple stores, including historical sales state 102 of all categories of products, historical sales state 104 of all stores and total sales state 106, is received by a pre-training module 110. The pre-training module 110 can pre-train a store model M1 and a category of products model M2 according to historical sales state of each store and each category of products. In step S202, state 117 of each store and state 113 of each category of products are obtained by a multi-store-multi-category training module 130 according to the total sales state 106, and horizontal and vertical relevance training based on the pre-trained category of products model M1 and store model M2 are conducted. In step S204, horizontal relevance between multiple stores, horizontal relevance between multiple categories of products and vertical relevance between multiple stores and multiple categories of products are determined by a state analysis module 120, so as to link multiple stores and multiple categories of products with high correlation to modify expected sales of each store and each category of products. In step S206, orders of multiple categories of products in each store are placed by an inventory decision module, and purchase volume of multiple categories of products in each store are determined.

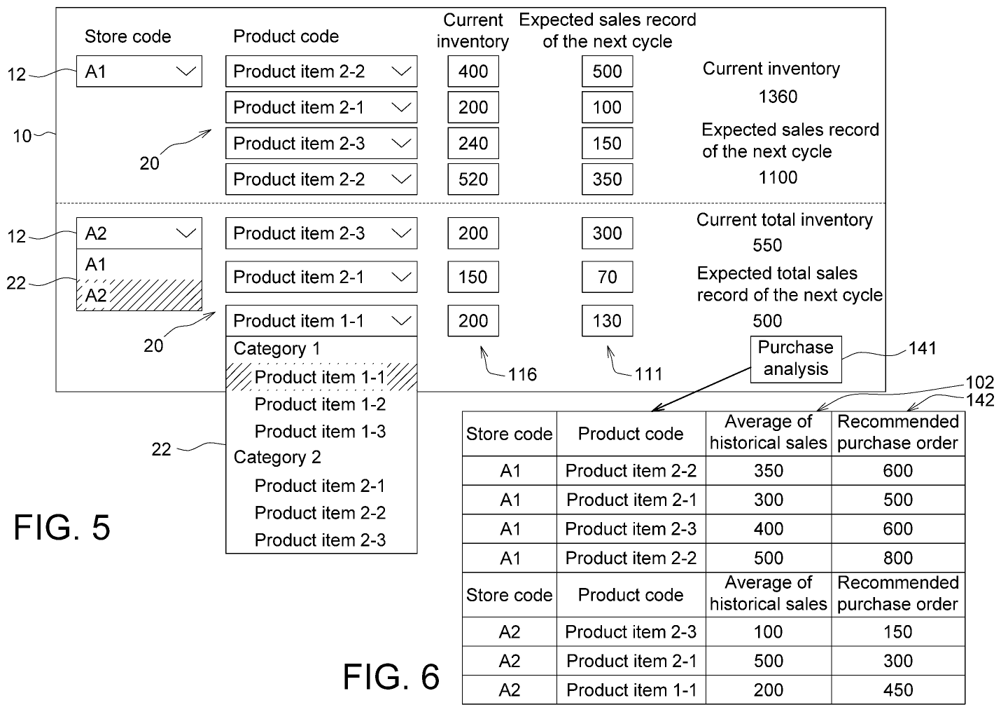

Referring to FIG. 5, a schematic diagram of an automated inventory management interface 10 according to an embodiment of the present disclosure is shown. The automated inventory management interface 10 can be displayed on an operation interface of a computer screen, and has a multi-store column 12, a multi-product column 20 and a drop-down form 22 for the user to choose or manage different stores and different categories of products. The inventory 116 of each category of products can be automatically generated by the state analysis module 120 according to the sales state in the current period or can be manually inputted by the manager. The sales record 111 in the next period is such as the sales of each store and each category of products in the next period forecasted by the state analysis module 120 according to the historical sales state 102 of all categories of products, the historical sales state 104 of all stores, and the total sales state 106 (average sales and standard deviation of sales).

Referring to FIG. 6, a schematic diagram of purchase analysis for different categories of products is shown. The purchase analysis menu 141, such as a popup menu, includes the historical sales state 102 of each category of products (average sales and standard deviation of historical sales over 13 weeks) and the purchase order 142 recommended by the inventory decision module 140 according to the sales 111 in the next period and the current inventory 116. Through the above purchase analysis menu 141, the user can obtain the purchase order 142 of each store and each category of products, reduce the labor for setting purchase parameters, reduce inventory cost, and reduce the risk of erroneous judgment of staff.

As disclosed above, the automated inventory management method and system of the above embodiments of the present disclosure are capable of increasing the precision of sales forecast, reducing inventory cost and risk of erroneous judgment of staff.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An automated inventory management system, comprising:
a pre-training module of a processor configured to receive historical sales states of multiple stores, comprising historical sales state of all categories of products, historical sales state of all stores and total sales state of each store and each category of products, wherein the pre-training module pre-trains models of each store and each category of products according to the historical sales state of all stores and all categories of products;
a multi-store-multi-category training module of the processor configured to obtain state of each store and state of each category of products according to the total sales state and conduct horizontal and vertical relevance training based on the pre-trained models of each store and each category of products;
a state analysis module of the processor configured to determine relevance between multiple stores, relevance between multiple categories of products and vertical relevance between multiple stores and multiple categories of products, so as to link multiple stores and multiple categories of products with high correlation to modify expected sales of each store and each category of products; and
an inventory decision module of the processor configured to place orders of multiple categories of products in each store and determine purchase volume of multiple categories of products in each store.

2. The system according to claim 1, wherein the pre-training module comprises a category pre-training module and a store pre-training module; the category pre-training module pre-trains each category of products model according to the historical sales state of all categories of products, and the store pre-training module pre-trains each store model according to the historical sales state of all stores.

3. The system according to claim 1, wherein the state analysis module calculates a reward feedback according to current sales and inventory of each store and each category of products in a current period and a purchase order in a previous period, and directly inputs the reward feedback of each store and each category of products and the sales state of each store and each category of products to the inventory decision module to place orders of each category of products in each store.

4. The system according to claim 3, wherein the inventory decision module further comprises using the purchase order matching the expected sales of each store and each category of products in a next period as a feedback data for calculating a purchase order matching each store and each category of products in the next two period and inputting the feedback data to the state analysis module to calculate the reward feedback.

5. The system according to claim 4, wherein the state analysis module is used to link up the reward feedback of top N stores with high correlation and the reward feedback of top N categories of products with high correlation to obtain a modified reward feedback of each store and each category of products.

6. The system according to claim 5, wherein the inventory decision module places orders of multiple categories of products in each store according to the modified reward feedback of each store and each category of products.

7. An automated inventory management method, comprising:
receiving historical sales states of multiple stores, comprising historical sales states of all categories of products, historical sales states of all stores and total sales state of each store and each category of products, by a pre-training module of a processor and pre-training models of each store and each category of products according to the historical sales states of all stores and all categories of products;
obtaining state of each store and state of each category of products by a multi-store-multi-category training module of the processor according to the total sales state and conducting horizontal and vertical relevance training based on the pre-trained models of each store and each category of products;
determining horizontal relevance between multiple stores, horizontal relevance between multiple categories of products and vertical relevance between multiple stores and multiple categories of products by a state analysis module of the processor, so as to link multiple stores and multiple categories of products with high correlation to modify expected sales of each store and each category of products; and
placing orders of multiple categories of products in each store by an inventory decision module of the processor and determining purchase volume of multiple categories of products in each store.

8. The method according to claim 7, wherein the pre-training module comprises a category pre-training module and a store pre-training module; the category pre-training module pre-trains each category of products model according to the historical sales state of all categories of products, and the store pre-training module pre-trains each store model according to the historical sales state of all stores.

9. The method according to claim 7, wherein the state analysis module calculates a reward feedback according to the sales and inventory of each store and each category of products in a current period and a purchase order in a previous period, and directly inputs the reward feedback of each store and each category of products and the sales state of each store and each category of products to the inventory decision module to place order of each category of products in each store.

10. The method according to claim 9, wherein the inventory decision module further comprises using the purchase order matching the expected sales of each store and each category of products in a next period as a feedback data for calculating a purchase order matching each store and each category of products in the period after the next period and inputting the feedback data to the state analysis module to calculate the reward feedback.

11. The method according to claim 10, wherein the state analysis module is configured to link the reward feedback of top N stores with high correlation and the reward feedback of top N categories of products with high correlation to obtain a modified reward feedback of each store and each category of products.

12. The method according to claim 11, wherein the inventory decision module places orders of multiple categories of products in each store according to the modified reward feedback of each store and each category of products.
